(19) United States
(12) Patent Application Publication
(10) Pub. No.: US 2020/0304882 A1
(43) Pub. Date: Sep. 24, 2020

(54) METHOD AND DEVICE FOR CONTROLLING THE SETTING OF AT LEAST ONE AUDIO AND/OR VIDEO PARAMETER, CORRESPONDING TERMINAL AND COMPUTER PROGRAM

(71) Applicant: Orange, Paris (FR)

(72) Inventors: Martinho Dos Santos, Thorigne Fouillard (FR); Chantal Guionnet, Cesson Sevigne (FR)

(21) Appl. No.: 16/088,025

(22) PCT Filed: Mar. 21, 2017
(86) PCT No.: PCT/FR2017/050661

§ 371 Date: Sep. 24, 2018

(30) Foreign Application Priority Data
Mar. 25, 2016 (FR) 1652630

(51) Int. Cl. H04N 21/485; H04N 21/43

(52) U.S. Cl. CPC H04N 21/4854; H04N 21/4307; H04N 21/4852

(57) ABSTRACT

A method is provided of controlling the setting of at least one audio and/or video parameter of a terminal which is able to render an audio and/or video content. The method can include, for an audio and/or video content to be rendered, the reception of an audio and/or video signal corresponding to said content. In a manner synchronized with the rendition of the content by the terminal, the method can include analyzing at least one characteristic of the audio and/or video signal received, and setting at least one audio and/or video parameter of the terminal as a function of the analyzed characteristic.

### FIELD OF THE INVENTION

The field of the invention is that of the rendition of contents by a user terminal. Such a content can be text, sound (or audio), images, videos, applications/services or else any combination of these various elements.

The invention applies equally to contents broadcast in real time on a user terminal, and to contents recorded beforehand in the latter.

More particularly, the invention applies to the control of the setting of the audio and/or video parameters of the terminal during rendition of the content.

The invention can in particular be implemented in a terminal furnished with a user interface and with a graphical interface, for example a tablet, a mobile telephone, a smartphone (“intelligent telephone”), a personal computer, a television connected to a communication network, etc.

### Presentation of the Prior Art

Today, to set the audio and/or video parameters of a rendition terminal, for example a television, the user accesses, via a menu which is displayed on their television, an interface for setting these parameters.

Prior to the rendition of a content or else during the rendition of the content, the user can thus manually set the audio and video parameters, some of which may or may not be predefined.

Such video parameters are for example color, contrast, shade, brightness, etc. Such audio parameters are for example volume, sound balance, audio frequency, etc.

This type of setting is not necessarily easy for a non-technophile user who does not always know how to rapidly access the setting interface and which parameters to set. It is furthermore tedious having regard to the large number of audio and/or video parameters that might be set. Therefore, it is fairly rare for the user to intervene to adjust the settings of their television after purchasing the latter.

Another drawback of current interfaces for setting audio and/or video parameters is that once the setting has been performed by the user, this setting applies automatically to all the contents that will be rendered subsequently on the television and in a uniform manner throughout the rendered content duration.

A need therefore exists for a solution making it possible to automatically set the audio and/or video parameters as a function of the content which is rendered, without particular intervention by the user, and to adapt the setting of these parameters in real time, throughout the duration of rendition of the content.

### Subject and Summary of the Invention

One of the aims of the invention is to remedy drawbacks of the aforementioned prior art.

For this purpose, a subject of the present invention relates to a method of controlling at least one audio and/or video parameter of a terminal which is able to render an audio and/or video content, implementing, for an audio and/or video content to be rendered, the reception of an audio and/or video signal corresponding to the content.

Such a method is noteworthy in that in a manner synchronized with the rendition of the content by the terminal, the method implements the following:
analysis of at least one characteristic of the audio and/or video signal received,
setting of at least one audio and/or video parameter of the terminal as a function of the characteristic analyzed.

Such a provision advantageously allows, in tandem with the rendition of a given content, dynamic adaptation of the audio and/or video parameters of the rendition terminal as a function of this content. Such adaptation does not require any particular intervention by the user on the audio and/or video settings of the terminal, prior to the rendition of the content or else in the course of rendition of the content.

This results in an improvement in the viewing and/or listening conditions throughout the duration of rendition of the content. In particular, the sensation of immersion of the user with respect to the content is distinctly more marked by comparison with the methods of audio and/or video setting of the prior art.

By rendition is meant either viewing a content, or listening to a content, or both at the same time.

The method of control according to the invention is for example implemented in a terminal, such as a set-top-box or else in a terminal connected to the set-top-box, such as for example a tablet, a television, etc.

According to a particular embodiment, the audio and/or video signal having been decomposed beforehand into a plurality of successive temporal sequences, the analysis of at least one characteristic of the audio and/or video signal received comprises, for a current temporal sequence of the plurality, an identification of at least one characteristic of the audio and/or video signal, said characteristic being associated with the current temporal sequence.

Such a provision makes it possible to associate automatically with each temporal sequence making up the audio and/or video signal one or more audio and/or video settings which are relevant with respect to the rendered portion of content corresponding to each temporal sequence.

If for example, the content considered is a film, certain scenes of which occur at night and others by day, the audio/video signal is decomposed beforehand into temporal sequences each corresponding to a string of day and night scenes. Thus, for example, during the rendition of the film on the terminal:
for night scenes, the audio and/or video parameters of the terminal are modified in a manner synchronized with the rendition of the content so as to display the night scenes for example in black and white, with a low brightness, while optionally decreasing the sound levels of the characters appearing on the screen,
for day scenes, the audio and/or video parameters of the terminal are modified in a manner synchronized with the rendition of the content so as to display the day scenes for example in color, with increased contrast and increased brightness, while optionally increasing the sound levels of the characters appearing on the screen.

According to yet another particular embodiment, the analysis of at least one characteristic of the audio and/or video signal received comprises a continuous identification of at least one item of information characterizing the audio and/or video signal.

Such a provision makes it possible to associate automatically and dynamically with a current instant of rendition of the content, one or more audio and/or video settings which are relevant with respect to the characteristics of the content rendered at this current instant.

The control of the setting of the audio and/or video parameters thus implemented makes it possible to increase the rate of modification of these parameters so as to adapt as faithfully as possible to the nature of the content rendered at a current instant, with the aim of optimizing the viewing and/or listening conditions, as well as the sensation of immersion of the user with respect to the content.

According to yet another particular embodiment, the characteristic of the audio and/or video signal is a metadatum characterizing the content at a current instant of rendition of the content.

Such a metadatum differs from the metadata conventionally allocated to the contents as a whole, in that it specifies a certain degree of emotion or of feeling of the user with respect to a sequence, rendered at a current instant, of the content.

Thus, such a metadatum consists for example in:
the type of sequence of the content: violent, calm, slow, fast, etc.
a sub-category of the genre of content: the strongest actions and the most relevant comments associated with the “sport” genre, the most agonizing or bloodiest sequences associated with the “horror” genre, the gag sequences associated with the “comedy” genre, etc.,
the emotion elicited by the content: stress, calm, strong sensations, agony, etc.

The setting of the audio and/or video parameters of the terminal is particularly enriched and alterable with respect to the few fixed settings proposed in the prior art, since it can be implemented as a function of a great deal of information characterizing the content, some of which information varies in the course of the rendition of the content.

According to yet another particular embodiment, the characteristic of the audio and/or video signal is respectively at least one image portion and/or at least one component of the sound.

Such a provision makes it possible to set the audio and/or video parameters by virtue of fine intra content analysis, in tandem with the rendition of the content.

An intra content analysis consists for example in detecting in relation to the current image:
a particular shape, such as for example a ball in the case where the content is for example a football match,
and/or one or more particular colors,
and/or one or more sound frequencies, such as for example, the sound frequency of the voice of a character or of the cry of an animal,
and/or the sound volume of a piece of music,
and/or the balance of sounds of a background noise,
etc.

An adaptation of the audio and/or video parameters of the rendition terminal is then implemented subsequent to this analysis with the aim of improving the user's visual and/or listening comfort.

According to yet another particular embodiment, the setting of said at least one audio and/or video parameter of the terminal, which has been implemented as a function of the analyzed characteristic, is modified as a function of at least one criterion related to the user of the terminal.

Such a provision advantageously makes it possible to supplement the adaptation of the audio and/or video parameters as a function of the content rendered, by an adaptation of these parameters as a function of criteria specific to the user of the terminal.

Thus the audio and/or video parameters which are initially set as a function of the content in accordance with the invention can be modified in a personalized manner, that is to say for example, by taking account of the user's tastes, habits, constraints (e.g.: auditory or visual deficiency), of the user's environment, such as for example the place (noisy or calm) where the content is rendered, the type of video and/or audio peripherals of the rendition terminal (size and shape of screens, of cabinets/loudspeakers), the day and/or the time of rendition of the content, etc.

According to yet another particular embodiment, the modification comprises a modulation, with respect to a predetermined threshold which is dependent on said at least one criterion related to the user of the terminal, of the value of said at least one audio and/or video parameter which has been set.

Such a modulation advantageously makes it possible to accentuate or else to attenuate, according to criteria specific to the user, the setting of the audio and/or video parameters which has been implemented as a function of the content.

The modulation implemented with respect to a predetermined threshold consists for example:
in applying predetermined multiplier coefficients to the values of the audio and/or video parameters set as a function of the content,
in incrementing or decrementing by a predetermined value n (e.g.: n=1) the values of the audio and/or video parameters set as a function of the content, the number of incrementations or of decrementations to be performed being likewise optionally predetermined as a function of the user's profile.

According to yet another particular embodiment, the modification comprises replacing the value of said at least one audio and/or video parameter which has been set with another value which is dependent on said at least one criterion related to the user of the terminal.

The advantage of such a provision is to make it possible to replace automatically, in a one-off manner or not, one or more values of the audio and/or video parameters set as a function of the content, as a function of a criterion specific to the user and known beforehand.

In the case for example where the user knows that a content contains scenes liable to offend the sensitivity of children (e.g.: containing vulgar themes, violent scenes, etc.), the user can on their own initiative, prior to the rendition of the content, select, via a dedicated interface, rules for automatically modifying the audio and/or video rendition of the content for certain sensitive scenes and/or language. Thus, for example, the sound may be cut off (volume at zero) and/or a black screen (brightness at zero) may be shown, in such a way that children do not hear the themes spoken about in certain scenes, or see these scenes.

The various aforementioned embodiments or characteristics of realization can be added independently or in combination with one another, to the method of control defined hereinabove.

The invention also relates to a device for controlling the setting of at least one audio and/or video parameter of a terminal which is able to render an audio and/or video content, such a device comprising a processing circuit which, for an audio and/or video content to be rendered, is designed to implement the reception of an audio and/or video signal corresponding to the content, such a device being adapted to implement the aforementioned method of controlling setting.

Such a device for controlling setting is noteworthy in that in a manner synchronized with the rendition of the content by the terminal, the processing circuit is designed furthermore to implement the following:
analysis of at least one characteristic of the audio and/or video signal received,
setting of at least one audio and/or video parameter of the terminal as a function of the characteristic analyzed.

The invention also relates to a terminal comprising the device for controlling display mentioned hereinabove.

Such a terminal is for example a set-top-box or else a terminal connected to the set-top-box, such as for example a tablet, a television, etc.

The invention further relates to a computer program comprising instructions for implementing the method of controlling setting according to the invention, when it is executed on a terminal or more generally on a computer.

Each of these programs can use any programming language, and be in the form of source code, object code, or of code intermediate between source code and object code, such as in a partially compiled form, or in any other desirable form.

The invention also envisages a recording medium readable by a computer on which is recorded a computer program, this program comprising instructions suitable for the implementation of the method of controlling setting according to the invention, such as described hereinabove.

Such a recording medium can be any entity or device capable of storing the program. For example, the medium can comprise a storage means, such as a ROM, for example a CD ROM or a microelectronic circuit ROM, a USB key, or else a magnetic recording means, for example a hard disk.

Moreover, such a recording medium can be a transmissible medium such as an electrical or optical signal, which can be conveyed via an electrical or optical cable, by radio or by other means. The program according to the invention can be in particular downloaded from a network of Internet type.

Alternatively, the recording medium can be an integrated circuit in which the program is incorporated, the circuit being adapted to execute or to be used in the execution of the aforementioned method of controlling display.

The device for controlling setting, the aforementioned corresponding terminal and computer program exhibit at least the same advantages as those conferred by the method of controlling setting according to the present invention.

### LIST OF FIGURES

Other advantages and characteristics of the invention will become more clearly apparent on reading the following description of several particular embodiments of the invention, given by way of simple illustrative and nonlimiting examples, and of the appended drawings, among which:

FIG. 1 presents in a schematic manner an architecture in which the method of controlling setting according to the invention is implemented;

FIG. 2 presents the simplified structure of a device for controlling the setting of the audio and/or video parameters according to one embodiment of the invention;

FIG. 3 presents in a schematic manner the steps of a method for controlling the setting of the audio and/or video parameters according to the invention;

FIGS. 4A to 4D represent various examples of audio and/or video signal characteristics analyzed during the implementation of the method of controlling setting of FIG. 3, as well as the way in which these characteristics are associated with the audio and/or video signal;

FIGS. 5A to 5C represent various examples of analysis of characteristics, such as implemented in the method of controlling setting of FIG. 3,

FIG. 6 represents an exemplary interface for defining rules specific to the user which are taken into account during the implementation of the method of controlling setting of FIG. 3.

### DESCRIPTION OF PARTICULAR EMBODIMENTS OF THE INVENTION

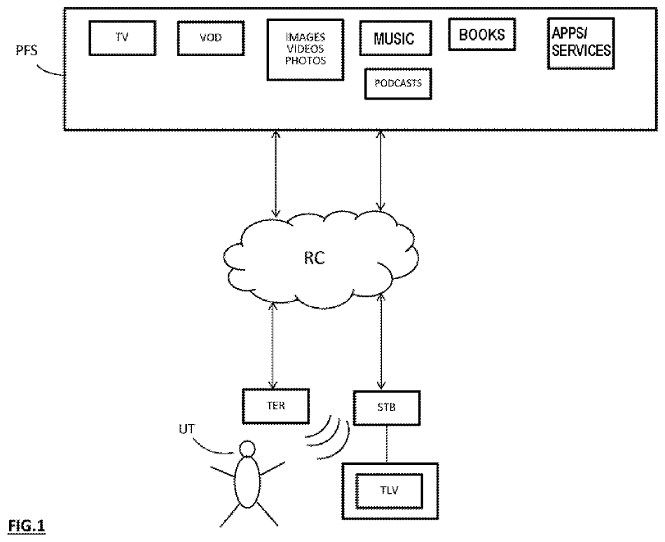

In relation to FIG. 1, an architecture in which the method of controlling the setting of at least one audio and/or video parameter according to the invention is implemented is presented.

Such an architecture comprises a terminal TER for accessing contents offered by a service platform PFS, via a communication network RC, such as for example of IP type (the English abbreviation standing for “Internet Protocol”). The service platform PFS offers the user UT of the terminal TER various contents such as for example:
televisual contents TV, in particular those for broadcasting programmed into a grid of programs,
VOD catalogs,
catalogs of videos and/or of images and/or of photos,
catalogs of music,
catalogs of podcasts,
catalogs of digital books,
catalogs of applications and/or of services.

The aforementioned architecture allows the user UT of the terminal TER to obtain access to the contents offered either in a situation of mobility or in a situation of sedentariness.

In a mobility situation, the terminal TER is for example a mobile telephone, a smartphone (“intelligent telephone”), a tablet, a laptop computer, etc.

In a sedentariness situation, the terminal TER could be a personal computer of PC type.

Still in a sedentariness situation, and as represented in FIG. 1, the terminal TER is for example composed:
of an access terminal STB which is able to receive and process the contents originating from the platform PFS,
of a rendition terminal, for example a television TLV such as represented in FIG. 1, able to render to the user UT the contents processed by the access terminal STB.

In an exemplary embodiment, the access terminal and the rendition terminal are grouped into a single terminal. This could for example entail a television containing a decoder of set-top-box type. In another example, the access terminal STB is a set-top-box and the rendition terminal TER is a tablet acting as rendition terminal connected to the set-top-box by means of a local network, for example wireless, in particular of the WiFi or PLC type (the abbreviation standing for “power-line communication”). According to other examples, not represented, the terminal TER could be a mobile telephone, a smartphone (“intelligent telephone”), the television TLV or a radio connected to a communication network, etc.

The user UT can interact with the access terminal STB with the aid of a conventional remote control or with the aid of the terminal TER which comprises for this purpose a suitably adapted remote control software application. The terminal TER then has the possibility of displaying an interface containing keys dedicated to prerecorded commands. Thus, the terminal TER exhibits the same functions as a conventional television remote control. For example, the user can request the selection of a content received originating from the services platform PFS, by simply pressing the direction keys “←”, “→”, “⬆”, “⬇” in a menu associated with viewing and/or listening to the contents received. The user can also validate the selected content by pressing the “OK” key. When the user activates a key of their remote control, a message comprising the command associated with this key is dispatched to the access terminal STB according to a communication protocol adapted to suit the local network used.

The access terminal STB, and likewise the terminal TER, furthermore comprise means of connecting to the communication network RC which may be, for example, of x-DSL, fiber or else 3G and 4G type.

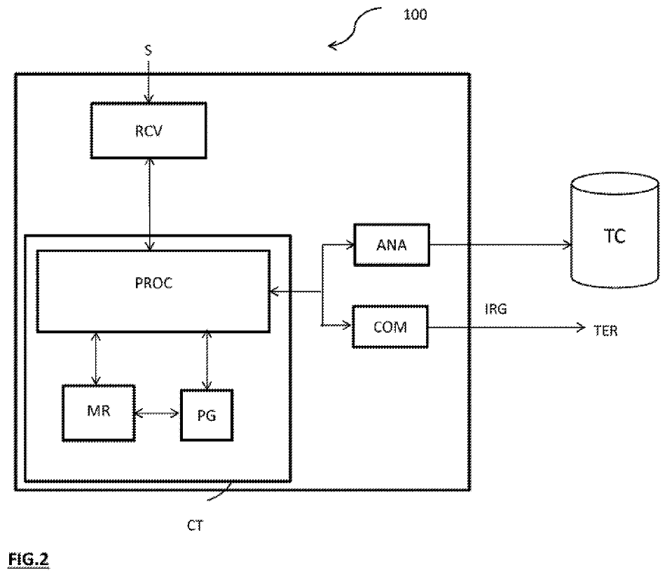

In relation to FIG. 2, the simplified structure of a device 100 for controlling the setting of the audio and/or video parameters of a content rendition terminal TER is now considered, according to an exemplary embodiment of the invention. Such a device for controlling setting is adapted to implement the method which will be described hereinbelow of controlling setting according to the invention.

For example, the device 100 comprises physical and/or software resources, in particular a processing circuit CT for implementing the method for setting the audio and/or video parameters according to the invention, the processing circuit CT containing a processor PROC driven by a computer program PG.

On initialization, the code instructions of the computer program PG are for example loaded into a RAM memory, denoted MR, before being executed by the processing circuit CT.

In accordance with the invention, for an audio and/or video content to be rendered by the terminal TER, the processing circuit CT is designed to implement:
the reception, via a reception interface RCV, of an audio and/or video signal S corresponding to the content to be rendered, such as for example transmitted by the platform PFS, and, in a manner synchronized with the rendition of the content,
the analysis, via an analyzer ANA, of at least one characteristic of the audio and/or video signal S,
the dispatching to the terminal TER, via a communication interface COM, of an audio and/or video parameter setting instruction, the setting then being dependent on said analyzed characteristic.

According to a first exemplary embodiment, the characteristic of the audio and/or video signal is the value of an audio and/or video parameter which is conveyed directly in the audio and/or video signal S.

A current audio parameter PAᵢ belongs to a set of predetermined audio parameters PA₁, PA₂, . . . , PAᵢ, . . . , PA_{M}, such that 1 Each of these parameters is associated with a value VA₁ for the audio parameter PA₁, VA₂ for the audio parameter PA₂, . . . VAᵢ for the audio parameter VAᵢ, . . . , VA_{M} for the audio parameter VA_{M}.

According to an exemplary embodiment, such a set contains three audio parameters, such as:
the sound level PA₁,
the sound frequency PA₂,
the balance of the low-pitched and high-pitched sounds PA₃.

A current video parameter PVⱼ belongs to a set of predetermined video parameters PV₁, PV₂, . . . , PVⱼ, . . . , PV_{N}, such that 1≤j≤N. Each of these parameters is associated with a value VV₁ for the video parameter PV₁, VV₂ for the video parameter PV₂, . . . VVⱼ for the video parameter VVⱼ, . . . , VV_{N} for the video parameter VV_{N}.

According to an exemplary embodiment, such a set contains three video parameters, such as:
the contrast PV₁,
the brightness PV₂,
the color saturation PV₃.

Prior to the transmission of the content to the terminal TER originating from the platform PFS, the content is firstly edited so as to associate with it, throughout its duration, one or more metadata characterizing not the content as a whole as is the case in the state of the art, but certain sequences of said content, these metadata being able to vary from one instant to the other in said content and/or be present at certain locations only of the content.

These new metadata specify, for example with respect to a type of content, a genre of content, a place associated with a content, etc. the level (very low, low, medium, high, very high) of the user's emotion or feeling with respect to a passage of the content rendered at a current instant.

Such metadata consist for example in:
the type of sequence of the content: violent, calm, slow, fast, etc.,
the type of sub-categories specifying the genre of content: for example for the “sport” genre, the strongest actions, the most voluble comments, for the “horror” genre, the chillingly scary scenes and the bloodiest scenes, for the “comedy” genre, the most hilarious gag sequences, for the “romantic” genre, the sequences of kisses, for the “pop-rock” genre, the sequences where one hears a riff or guitars saturated on a musical piece, etc.,
a particular instant of the content which occurs in the daytime or in the year, or else a daytime or evening atmosphere, etc.,
the type of place associated with a sequence of the content: indoor, outdoor, town, countryside, sea, mountain, etc.,
the emotion elicited by the content: stress, calm, strong sensations, agony, etc.

As regards the “emotion” metadatum, the latter is obtained beforehand on the basis of a measurement of psycho-physiological parameters (heartbeat, arterial pressure, body temperature, cutaneous conductance, etc.) felt by a panel of people to whom the content is rendered. These parameters also express the variations of these emotions during viewing (or any other form of visual and/or sound rendition) of the content. A reference recording is then generated, by combining the recordings obtained with the reference people of the panel. The combination consists for example of an average normalized for each instant of a part or of the totality of the content duration. In order for this normalized average to be representative of the population, the panel comprises a sufficient number of people with no particular health problem and the captures of values are performed under stable conditions of rendition of the content.

Once the characterization of the content has been performed, for an instant or a considered temporal sequence of the content, at least one of the metadata associated with this instant or with this temporal sequence is itself associated with at least one value of an audio and/or video parameter, such as selected from a range extending for example from 1 to 10.

According to a second exemplary embodiment, the characteristic of the audio and/or video signal S is an indicator of a metadatum associated beforehand with an instant or with a temporal sequence of the content. As will be detailed further on in the description, such an indicator is conveyed in a sub-stream synchronized with the audio and/or video signal.

The implementation of this second embodiment requires the prior construction of a correspondence table TC, a non-exhaustive example of which is represented hereinbelow.

| Metadata | Audio parameters | Video parameters |
|---|---|---|
| MD₁ = romantic | sound level = 4 | contrast = 4 |
| (level++) | | brightness = 5 |
| MD2 = night | sound level = 3 | brightness = 2 |
| | sound balance = 5 | |
| MD3 = gag | sound level = 6 | brightness = 8 |
| | sound frequency = 7 | |
| | sound balance = 8 | |
| MD4 = agony | sound level = 8 | brightness = 2 |
| | | color saturation = 8 |

As represented in FIG. 2, the correspondence table TC is external to the device for controlling setting 100, the audio and/or video parameter(s) being delivered on request of the device 100, via the communication network RC, each time the latter analyzes the audio and/or video signal S considered. As a variant, the table TC could be stored in a dedicated memory of the device 100.

According to a third exemplary embodiment, the characteristic of the audio and/or video signal S is either at least one current image portion, or at least one current component of the sound, or at least one current image portion and at least one current component of the sound.

A current image portion is for example:
a particular shape, such as for example a ball in the case where the content is for example a football match,
and/or one or more particular colors,
etc.

A current component of the sound is for example:
one or more sound frequencies, such as for example, the sound frequency of the voice of a character or of the cry of an animal,
and/or the sound volume of a piece of music,
and/or the balance of the sounds of a background noise,
etc.

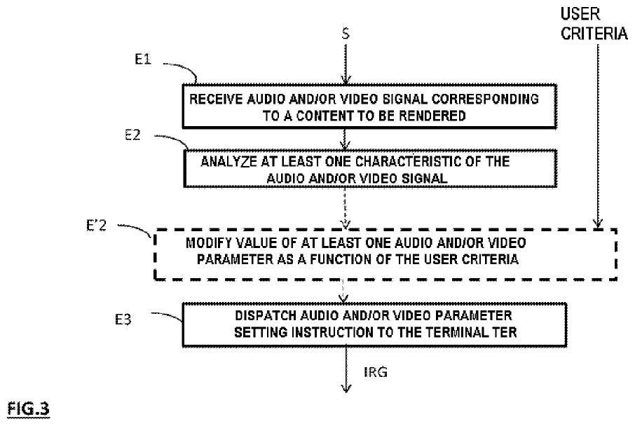

In relation to FIG. 3, the steps of the method of controlling setting of at least one audio and/or video parameter are now presented in accordance with an embodiment according to the invention. In the embodiment represented, said method of controlling setting is implemented by the device 100 represented in FIG. 2.

In the course of a step E1 represented in FIG. 3, the interface RCV of FIG. 2 receives an audio and/or video signal S corresponding to a content to be rendered by a terminal TER of the user UT, such as for example a tablet.

In a manner synchronized with the rendition of the content by the terminal TER:
in the course of a step E2 represented in FIG. 3, the analyzer ANA undertakes the analysis of at least one characteristic of the audio and/or video signal received,
in the course of a step E3 represented in FIG. 3, the communication interface COM dispatches to the terminal TER, according to a communication protocol suitable for the local network, an instruction IRG for setting of at least one audio and/or video parameter, whose value is dependent on the characteristic analyzed.

Thus, in a particularly advantageous manner, the audio and/or video parameters are modified dynamically over the duration of rendition of the content, without the user themself undertaking a setting of their terminal TER, prior to the rendition of the content or else in the course of the latter's rendition. The quality of the rendition of the content is thus higher than in the audio and/or video rendition devices of the prior art. The sensation of immersion of the user in the content is also made stronger and more realistic.

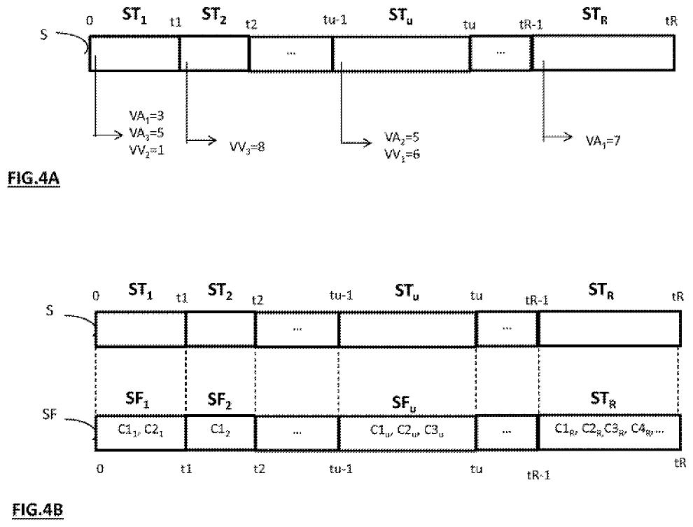

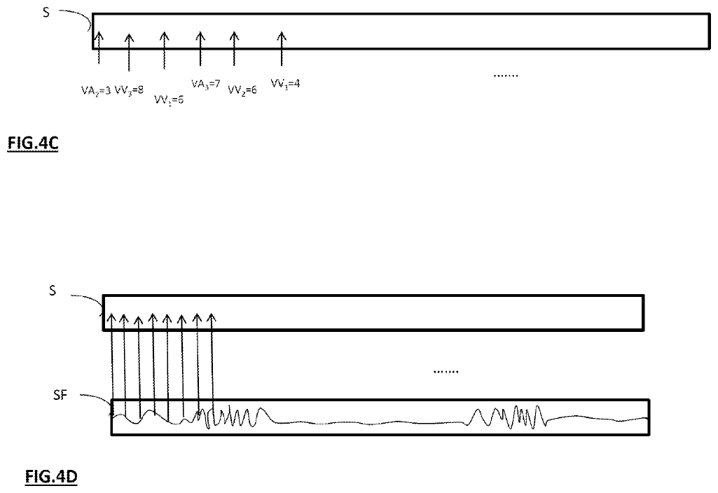

According to a first exemplary embodiment represented in FIG. 4A, the audio and/or video signal S having been decomposed prior to the transmission of the content, into a plurality of successive temporal sequences ST₁, ST₂, . . . , STᵤ, . . . , ST_{R}, such that 1≤u≤R, the analysis of at least one characteristic of the audio and/or video signal received comprises, for a current temporal sequence STᵤ of said plurality, an identification of at least one characteristic C1ᵤ of the audio and/or video signal, which characteristic is associated with said current temporal sequence.

In FIG. 4A, each temporal sequence exhibits a start and end instant. The temporal sequence ST₁ exhibits a start instant, 0, and an end instant, t1. The temporal sequence ST₂ exhibits a start instant, t1, and an end instant, t2, etc.

The temporal sequences are not necessarily of the same duration. In the case for example where the content is a film, each sequence may be composed of a string of scenes corresponding to a particular action of the film. In the case for example where the content is a song, each temporal sequence may be composed of the first couplet, of the second couplet, of the refrain, etc.

Prior to the transmission of the content, for at least one temporal sequence STᵤ considered, is associated at least one characteristic C1ᵤ of the audio and/or video signal portion corresponding to this current temporal sequence.

In the example of FIG. 4A, the characteristic C1ᵤ is:
either the value VAᵢ of an audio parameter PAᵢ belonging to the aforementioned set of predetermined audio parameters PA₁, PA₂, . . . , PAᵢ, . . . , PA_{M},
or the value VVⱼ of a video parameter PVⱼ belonging to the aforementioned set of predetermined video parameters PV₁, PV₂, . . . , PVⱼ, . . . , PV_{N}.

Such a characteristic is conveyed directly in the audio and/or video signal S, in the form of a number of bytes dependent on the value of the audio and/or video parameter considered.

In the example represented, there exist one or more values of audio and/or video parameters per temporal sequence.

For each rendered portion of content corresponding to each temporal sequence considered, the terminal TER applies the audio and/or video parameter values transmitted in the setting instruction IRG dispatched by the device 100 of FIG. 2. The values of other types of audio and/or video parameters not present in the setting instruction IRG are applied by the terminal by default, in a similar manner to the state of the art.

For example, dealing with temporal sequence ST₂, the setting instruction IRG contains the value VV₃=8 which, in the example represented, corresponds to the color saturation value. During the rendition of the content portion corresponding to the temporal sequence ST₂, the terminal TER applies this value VV₃ of setting and applies the values of the other audio and/or video parameters defined by default in the terminal TER or else defined beforehand by the user UT.

By way of alternative to this first exemplary embodiment, according to a second example represented in FIG. 4B, the characteristic C1ᵤ is a metadatum describing the content portion associated with the temporal sequence STᵤ.

If for example the temporal sequence STᵤ is associated with scenes of violence on a warship, the following three characteristics are for example associated with this sequence:
C1ᵤ=“sea” metadatum,
C2ᵤ=“violence” metadatum,
C3ᵤ=“war” metadatum.

In accordance with the invention, as represented in FIG. 4B, such characteristics are conveyed in a sub-stream SF synchronized with the audio and/or video signal S. Thus, the characteristics C1ᵤ, C2ᵤ and C3ᵤ are contained in a portion of the sub-stream SF, denoted SFᵤ, which is synchronized with the temporal sequence STᵤ.

Still by way of example, if the first temporal sequence ST₁ is associated with romantic scenes occurring during the second world war, the following two characteristics are for example associated with this sequence:
C1₁=“passion” metadatum,
C2₁=“war” metadatum.

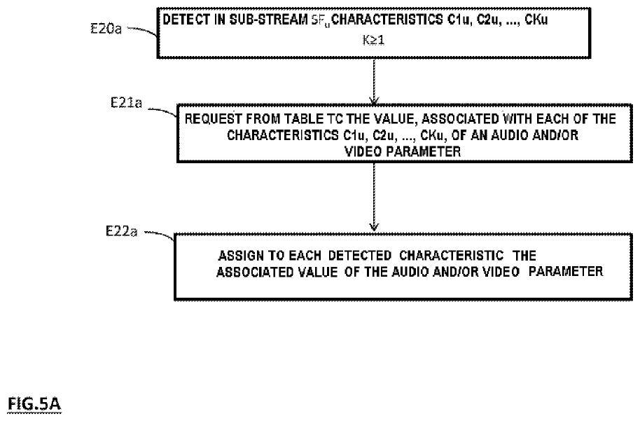

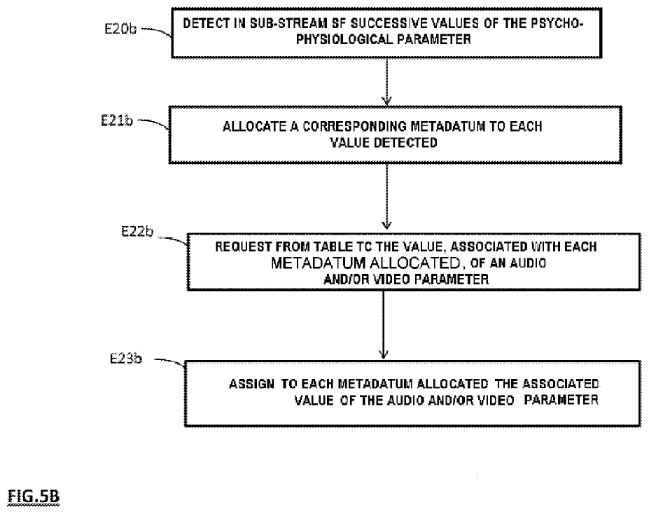

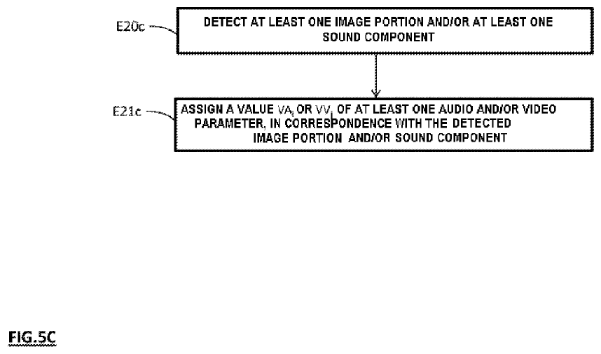

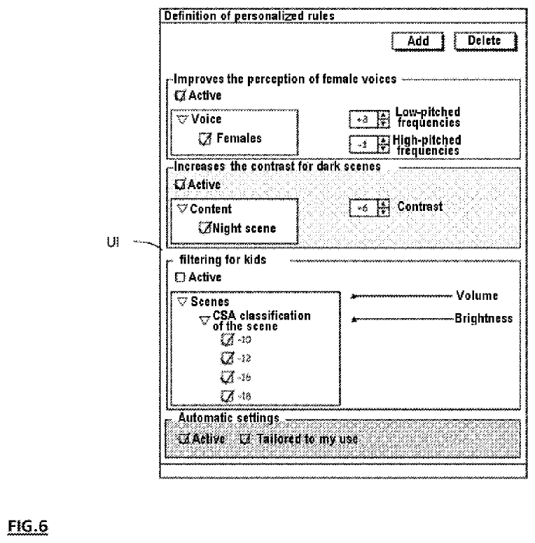

In accordance with the second embodiment of FIG. 4B, as represented in FIG. 5A, the analysis E2, such as implemented in FIG. 3, of the audio and/or video signal S consists, for a considered temporal sequence STᵤ, in:
at E20a, detecting in the corresponding sub-stream SFᵤ one or more characteristics C1ᵤ, C2ᵤ, . . . , CKᵤ, with K≥1,
for each of the detected characteristics, at E21a, requesting from the correspondence table TC, the value associated therewith of an audio and/or video parameter,
at E22a, assigning to each detected characteristic, the value associated therewith of the audio and/or video parameter.

According to a third exemplary embodiment represented in FIG. 4C, the audio and/or video signal S is not decomposed into several temporal sequences. It is simply associated continuously with at least one item of information characterizing it.

In the example of FIG. 4C, such an item of information is:
either the value VAᵢ of an audio parameter PAᵢ belonging to the aforementioned set of predetermined audio parameters PA₁, PA₂, . . . , PAᵢ, . . . , PA_{M},
or the value VVⱼ of a video parameter PVⱼ belonging to the aforementioned set of predetermined video parameters PV₁, PV₂, . . . , PVⱼ, . . . , PV_{N}.

Such a characteristic is conveyed directly in the audio and/or video signal S, in the form of a number of bytes dependent on the value of the audio and/or video parameter considered.

In the example represented, in tandem with the rendition of the content by the terminal TER, the analyzer ANA of the device 100 of FIG. 2 reads, in the signal S, each audio and/or video parameter value one after the other.

The terminal TER then directly applies each audio and/or video parameters value transmitted in each setting instruction IRG dispatched by the device 100 of FIG. 2. In the example represented in FIG. 4C, this entails values VA₂=3, then VV₃=8, then VV₁=6, then VA₃=7, then VV₂=6, then VV₁=4, etc. The values of other types of audio and/or video parameters not present in the setting instruction IRG are applied by the terminal by default, in a similar manner to the state of the art.

By way of alternative to this third exemplary embodiment, according to a fourth embodiment represented in FIG. 4D, the item of information continuously characterizing the audio and/or video signal S is a reference recording of the evolution, in the course of the prior rendition of the content, of a psycho-physiological parameter such as for example the heartbeat, the arterial pressure, the body temperature, cutaneous conductance, etc.

In accordance with the invention, as represented in FIG. 4D, such a recording is conveyed in a sub-stream SF synchronized with the audio and/or video signal S.

Of course, several different sub-streams may be synchronized with the audio and/or video signal S. Thus, the audio and/or video signal S could for example be synchronized with a first sub-stream transporting the recording of the heartbeat and a second sub-stream transporting the recording of the arterial pressure.

As represented in FIG. 5B, the analysis E2, such as implemented in FIG. 3, of the audio and/or video signal S then consists, in a continuous manner and synchronized with the rendition of the content by the terminal TER, in:
at E20b, detecting in the sub-stream SF the values of the psycho-physiological parameter,
for each of the detected values, at E21b, allocating a corresponding metadatum, such as “stress”, “calm”, “agony”, etc.,
at E22b, requesting from the correspondence table TC, the value, associated with each corresponding metadatum, of an audio and/or video parameter,
at E23b, assigning to each corresponding metadatum, the value associated therewith of the audio and/or video parameter.

According to a fifth embodiment represented in FIG. 5C, the analyzer ANA undertakes an intra-content analysis.

For this purpose, the analysis E2, such as implemented in FIG. 3, of the audio and/or video signal S then consists, in a continuous manner and synchronized with the rendition of the content by the terminal TER, in:
at E20c, detecting at least one image portion and/or one component of the sound which, preferably, recur throughout the content,
at E21c, assigning a value VVⱼ or VAᵢ of at least one audio and/or video parameter, in correspondence with the detected image portion and/or component of the sound.

In the case for example where the content is a football match, a current image portion is for example the ball, which is detected by a shape recognition algorithm. The analyzer ANA will assign for example a much higher value VV₁ of contrast to the ball than that programmed beforehand into the terminal TER.

By way of alternative, the higher contrast may be applied to the whole image and not just to the ball.

In the case for example where the content is a song performed as a duet by a male singer and a female singer, an audio component is one of the audio tracks corresponding respectively to the voice of the male singer and to the voice of the female singer. The analyzer ANA will assign for example a particular value VA₂ of sound frequency to the audio track corresponding for example to the voice of the female singer, so as to make the audio rendition of the content more striking or more comfortable.

The various embodiments which have just been described with reference to FIGS. 4A to 4D and 5A to 5C can of course be combined together for a still higher enrichment of audio and/or video parameters to be set automatically.

Furthermore, the setting of the audio and/or video parameters implemented with the aid of these various embodiments can be modified as a function of at least one criterion related to the user UT.

Thus the audio and/or video parameters which are initially set as a function of the content in accordance with the various embodiments described hereinabove can be modified in a personalized manner, that is to say, for example, by taking account of the user's tastes, habits, constraints (e.g.: auditory or visual deficiency), of the user's environment, such as for example the place (noisy or calm) where the content is rendered, the type of video and/or audio peripherals of the rendition terminal TER (size and shape of screens, of cabinets/loudspeakers), the day and/or the time of rendition of the content, etc.

For this purpose, prior to the rendition of a content, the platform PFS retrieves these various user criteria.

Such a retrieval is for example implemented by extracting information from a content viewing/listening history of the user UT which is uploaded to the platform PFS via the communication network RC of FIG. 1.

According to another example, on request of the user UT from the platform PFS, the user has the possibility, via a dedicated interface which is displayed on their terminal TER or their television TLV, of manually declaring their tastes, their habits and their constraints. For example, the user UT can indicate that they watch television in their bedroom between 20 h and 22 h, on their television TLV having a 26-inch High-Definition screen. According to another example, the user UT may indicate that they are color blind or else bothered by certain sound frequencies, etc.

Subsequent to the retrieval of the user's criteria, with reference to FIG. 3, following the implementation of the analysis step E2, there is undertaken, at E′2, a modification of the audio and/or video parameter setting values, as a function of the user's criteria retrieved by the platform PFS.

Step E′2 being optional, it is represented dashed in FIG. 3.

According to a first embodiment, the modification E′2 comprises a modulation, with respect to a predetermined threshold which is dependent on said at least one user criterion of the terminal, of the value of the audio and/or video parameter or parameters which have been set on completion of step E2.

The modulation implemented with respect to a predetermined threshold consists for example:
in applying predetermined multiplier coefficients to the values of the audio and/or video parameters set as a function of the content,
in incrementing or decrementing by a predetermined value n (e.g.: n=1) the values of the audio and/or video parameters set as a function of the content, the number of incrementations or of decrementations to be performed being likewise optionally predetermined as a function of the user's profile.

For example, if the user UT has declared beforehand to the platform PFS that they have deficient hearing, the value VA₁ allocated to the sound level parameter PA₁ is automatically increased by n=3 before the dispatching, at E3, of the setting instruction IRG.

According to another example, if the user UT has declared beforehand to the platform PFS that they have deficient sight, if for example two values VV₁ and VV₃ have been respectively allocated in step E2 to the video parameters PV₁ of contrast and PV₃ of color saturation, two predetermined multiplier coefficients are applied to the values VV₁ and VV₃ before the dispatching, at E3, of the setting instruction IRG.

According to a second embodiment, the modification E′2 comprises replacing the value of the audio and/or video parameter or parameters which have been set on completion of step E2, with another value which is dependent on at least one criterion related to the user of the terminal.

For example, in the case of the analysis, such as implemented in FIG. 5C, of the characteristics of the audio and/or video signal, if the user UT has declared beforehand to the platform PFS that they were color blind, before the dispatching, at E3, of the setting instruction IRG, the color zones that they fail to perceive in the current image are replaced respectively with color zones that they succeed in perceiving.

According to another example, still in the case of the analysis such as implemented in FIG. 5C, of the characteristics of the audio and/or video signal, if the user UT has declared beforehand to the platform PFS that they were bothered by high frequencies, if high frequencies such as these are present in certain components (tracks) of the audio signal, they are replaced with lower frequencies of the spectrum before the dispatching, at E3, of the setting instruction IRG.

An exemplary interface UI, with the aid of which the user UT declares their own specific criteria which will influence the analysis implemented by the analyzer ANA of FIG. 2, will now be described in relation to FIG. 6.

In the example represented, these criteria take the form of rules which supplement or substitute for the automatic settings implemented in the device 100 of FIG. 2.

In the example represented, four rules are defined:
Automatic settings,
Filtering for kids,
Increases the contrast for dark scenes,
Improves the perception of female voices.

Dealing with the rule “filtering for kids”, the user can impose on the device 100 a setting value for certain audio/video parameters, for example volume and brightness. The setting values are selected by the user by moving for example a cursor associated with each parameter.

Dealing with the rule “increases the contrast for dark scenes”, the user can impose on the device 100 a value of contrast that they have the possibility of incrementing or of decrementing according to their needs.

Dealing with the rule “improves the perception of female voices”, the user can impose on the device 100 a value of low-pitched frequencies and a value of high-pitched frequencies, that they have the possibility of incrementing or of decrementing according to their needs.

Moreover, these rules may or may not be adapted automatically as a function of the usages and habits of the user.

Each new rule will be stacked on top of the previous one with the aid of the “add” button.

It is possible to delete a rule with the aid of the “delete” button and to modify the order of the rules.

In the example represented, the rules are analyzed from top to bottom, that is to say (from highest to lowest priority). As soon as the definition of a rule corresponds to the viewed content, the rule is applied.

The invention which has just been described hereinabove thus exhibits numerous advantages, such as for example:
improving the audiovisual comfort specific to certain types of contents, such as for example:
   improving the contrast, the green color of the lawn and the frequency band of the voice so as to profit fully from a football match, to view the ball better and to maximize the understanding of the comments,
   improving a musical concert: balance of sounds and colors slightly saturated (psychedelic ambience), etc.,
intensifying certain scenes, for example by:
   increasing the sound of scenes with suspense or which are very tense,
   by saturating the colors for horror scenes,
   by improving the contrast for dark scenes,
decreasing the impact of certain scenes in the case where the content is rendered to sensitive people, for example by:
   combining contrast and brightness, or even the sound volume, to decrease the visibility of difficult scenes (violence, horror, etc.),
   adapting the colors for color blind people: in each image, replacing of poorly perceived colors with others which allow the scene to be better felt.

### ILLUSTRATIVE EXAMPLES

Agnès has a small hearing deficiency in a particular band of frequencies. Agnès configures her system so that the voice frequencies of the contents which would occur in this band are shifted so that she hears them better.

Martin does not entirely trust contents termed “universal” for his children. Thus, he configures his system so that all the unsuitable scenes are artificially blanked out by an automatic adaptation of the volume (sound cut off) and of the brightness of the image (black screen). Martin is thus more relaxed and reassured.

The last film seen by Paul was a toing and froing between romantic scenes and scenes with suspense and agony. The subject was admittedly somewhat complicated but thanks to the accentuations of contrast, the settings are attenuated or amplified throughout the film. Paul thus has the impression of having felt truly strong emotions, close to those that he feels in reality.

It goes without saying that the embodiments which have been described hereinabove were given purely by way of wholly nonlimiting indication, and that numerous modifications can be easily made by the person skilled in the art without however departing from the scope of the invention.

1. A method of controlling the setting of at least one audio and/or video parameter of a communications terminal configured to render audio and/or video content, the method comprising:
receiving an audio and/or video signal corresponding to audio and/or video content to be rendered; and
in a manner synchronized with the rendition of the content by the terminal:
analyzing at least one characteristic of the audio and/or video signal received:
setting at least one audio and/or video parameter of the terminal as a function of the analyzed characteristic.

2. The method of claim 1, wherein the audio and/or video signal has been decomposed beforehand into a plurality of successive temporal sequences, and wherein analyzing at least one characteristic of the audio and/or video signal received comprises, for a current temporal sequence of the plurality of successive temporal sequences, identifying at least one characteristic of the audio and/or video signal, the characteristic being associated with said current temporal sequence.

3. The method of claim 1, wherein analyzing at least one characteristic of the audio and/or video signal received comprises a continuous identification of at least one item of information characterizing the audio and/or video signal.

4. The method of claim 1, wherein the characteristic of the audio and/or video signal comprises a metadatum characterizing the content at a current instant of rendition of the content.

5. The method of claim 1, wherein the characteristic of the audio and/or video signal is respectively at least one image portion and/or at least one sound component.

6. The method of claim 1, wherein setting the at least one audio and/or video parameter of the terminal as a function of the analyzed characteristic, further comprises setting the at least one audio and/or video parameter of the terminal as a function of the analyzed characteristic and as a function of at least one criterion related to the user of the terminal.

7. The method of claim 6, wherein setting the at least one audio and/or video parameter of the terminal as a function of the analyzed characteristic and as a function of at least one criterion related to the user of the terminal comprises modulating, with respect to a predetermined threshold which is dependent on said at least one criterion related to the user of the terminal, of the value of the at least one audio and/or video parameter.

8. The method as claimed in claim 6, wherein setting the at least one audio and/or video parameter of the terminal as a function of the analyzed characteristic and as a function of at least one criterion related to the user of the terminal comprises replacing the value of the at least one audio and/or video parameter with another value which is dependent on said at least one criterion related to the user of the terminal.

9. A device for controlling the setting of at least one audio and/or video parameter of a communications terminal configured to render audio and/or video content, the device comprising a processing circuit configured to:
implement the reception of an audio and/or video signal corresponding to audio and/or video content to be rendered; and in a manner synchronized with the rendition of the content by the terminal, implement:
analysis of at least one characteristic of the audio and/or video signal received,
setting of at least one audio and/or video parameter of the terminal as a function of the analyzed characteristic.

10. A communications terminal comprising the control device of claim 9.

11. A computer having stored thereon instructions, which when executed by the computer, cause the computer to perform the method of claim 1.

12. A non-transitory computer readable medium having stored thereon instructions, which when executed by a processor, cause the processor to perform the method claim 1.
